(19) United States
(12) Patent Application Publication
(10) Pub. No.: US 2007/0107998 A1
(43) Pub. Date: May 17, 2007

(54) Coupling/brake combination

(75) Inventors: Herbert Vogt, Mauerstetten (DE); Johann Eberle, Irsee (DE); Ludwig Braun, Hurlach (DE)

Correspondence Address: W. NORMAN ROTH, 523 W. 6TH STREET, SUITE 707, LOS ANGELES, CA, 90014, US

(73) Assignee: Chr. Mayr GmbH & Co KG, Mauerstetten (DE)

(21) Appl. No.: 10/565,176

(22) PCT Filed: Aug. 2, 2004
(86) PCT No.: PCT/EP04/08654

§ 371 Date: Jan. 19, 2006

(30) Foreign Application Priority Data
Aug. 4, 2003 (DE) 10335639.8

(51) Int. Cl. B60L 7/00

(52) U.S. Cl. 188/163

(57) ABSTRACT

The invention relates to a coupling/brake combination, characterised in that the unit is embodied as a so-called lantern (connector piece) with integrated static current operated spring pressure brake and with a central hub (for example, a bellows coupling or a plug-in coupling or a shaft in hollow shaft) between the input side (motor) and output side (gearbox/spindle/or similar) and the brake is arranged on the output side (gearbox/spindle side). The unit is embodied such that both shaft levels from the input side (motor) and output side (gearbox/spindle/or similar) lie directly adjacent each other in the central hub such that the shortest possible length of the whole unit can be achieved.

The present invention is based on a state of the art as established by applicant's DE 201 05 746.8 or WO 02/084 841.

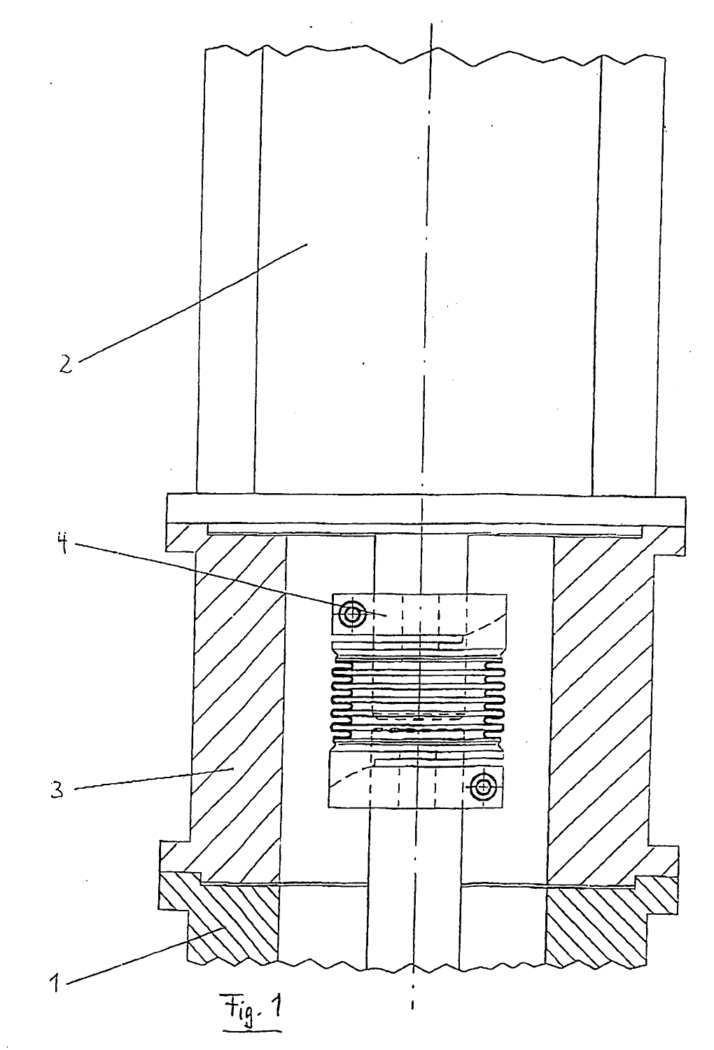

In the prior-art design, an elastically flexible coupling such as a bellows-type coupling or a plug-in coupling including a resilient star coupling member is provided between the motor shaft and the transmission input shaft, or the spindle, to be driven and the assembly then shielded from the environment by a connector element constituting a so-called “lantern”—see FIG. 1.

In the prior-art design it is assumed that the brake is mounted on a servo motor acting on the power input side of the brake. The second shaft—to be connected through the bellows coupling—may be part of a transmission, a spindle, a ball screw or the like. A drawback of this construction is its relatively great length. Also, if the coupling/brake combination is to be mounted in a vertical position, a number of additional problems have to be considered.

For example, if the coupling is broken by external influence, the suspended machine elements below it may “crash”, potentially causing considerable damage.

The same problem of suspended machine elements crashing arises if the drive motor is defective and has to be removed for repair or replacement.

Besides, it is desirable in many specific mounting situations to have available a coupling/brake combination featuring a particularly short structural axial length.

It is the object of the present invention to eliminate the aforesaid problems in a manner as efficient as possible.

In accordance with the present invention, this object is achieved by designing the coil carrier housing of the brake including the magnetic coil to correspond approximately to the external dimensions of the aforesaid “lantern”. To this end, the brake rotor including its friction liners and its teeth (or splines) are mounted directly on the hub connected with the bellows coupling and its clamps or with any other flexible coupling present. What this means is that the brake is mounted on the power output side so as to continue to perform its braking function for downstream machine components also in case the coupling fails or the drive motor has to be removed for repair or the like.

The inventive solution results in the following advantages:
1. After the brake has been mounted directly on the transmission or spindle shaft by its peripheral teeth or splines, no further parts of the coupling exist between the motor and the transmission which would cause the brake to become ineffective if the coupling broke.
2. Should the motor have to be replaced, this is easily done as the brake is mounted directly on the power output side so that the braking effect is maintained. As a result, it is possible to withdraw the motor shaft from the coupling; the braking effect will still be present.
3. By configuring the coupling/brake combination in the way of the aforesaid “lantern”, the end faces of the two shafts (motor shaft, transmission or spindle shaft) can be arranged in their closest proximity possible so as not to waste any construction space.
4. The conventional “lantern” with the bellows coupling therein or a star-type plug-in coupling therein is not needed any longer; inserted instead is a complete brake with its corresponding housing and having its center configured to receive and accommodate a flexible coupling such as a bellows coupling or a star-type plug-in coupling. This results in optimum use of the available space and in a simple and compact design.

The present invention is explained in greater detail now under reference to the attached drawings.

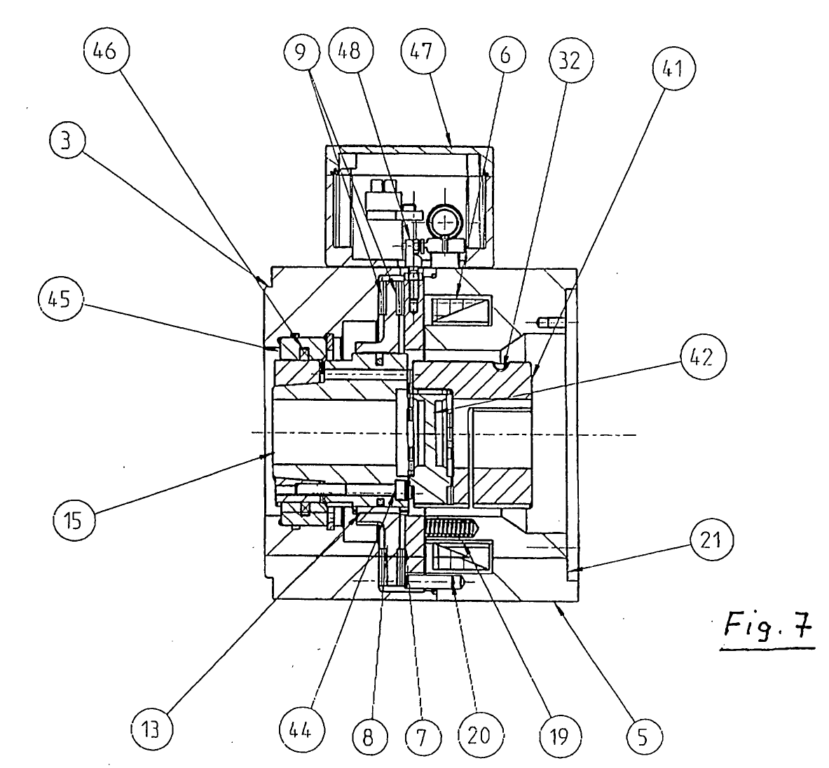

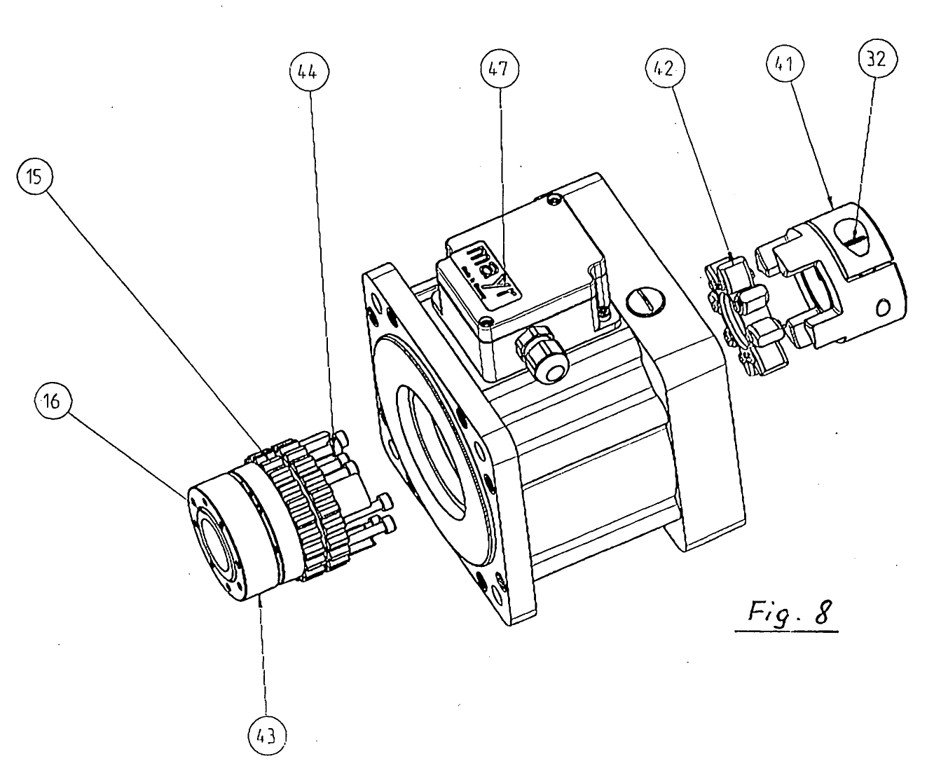

FIG. 1 schematically shows a typical prior-art mounting situation involving a “lantern” (=connector sleeve 3) in a vertical drive train, e.g. between a drive motor 2 and a transmission or gear box 1; the present invention substantially improves this mounting situation, with drive motor 2 connected to transmission/gear box 1 via a coupling such as a bellows coupling or a star-type plug-in coupling (see FIGS. 7 and 8);

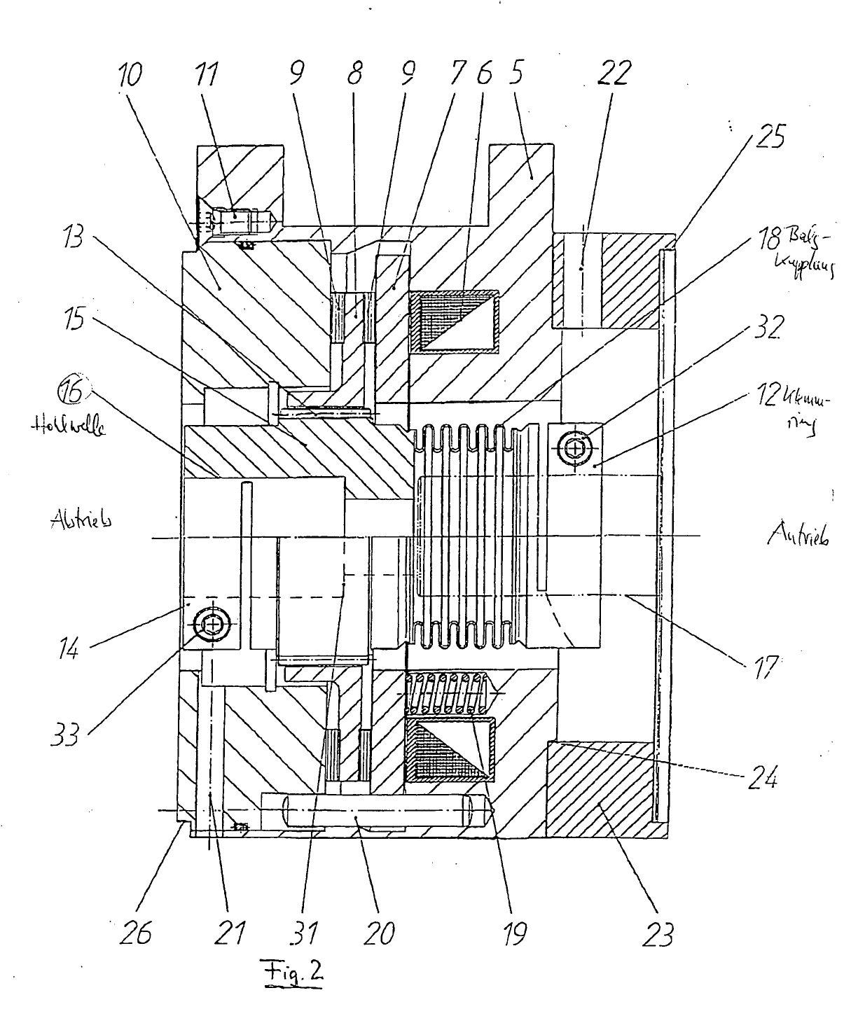

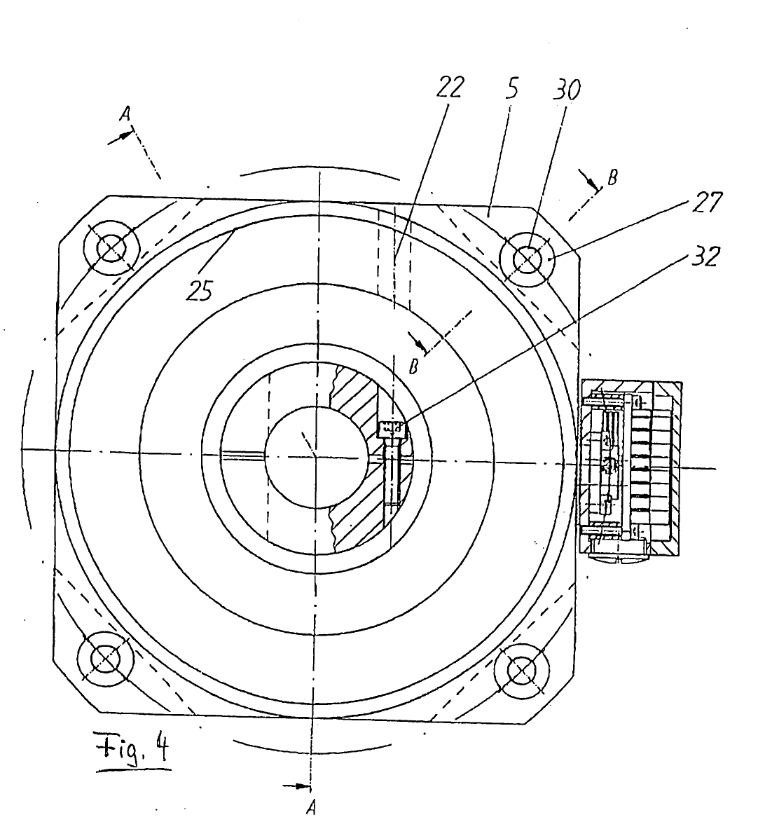

FIG. 2 completely shows a first embodiment of the invention (section along line A-A in FIG. 4);

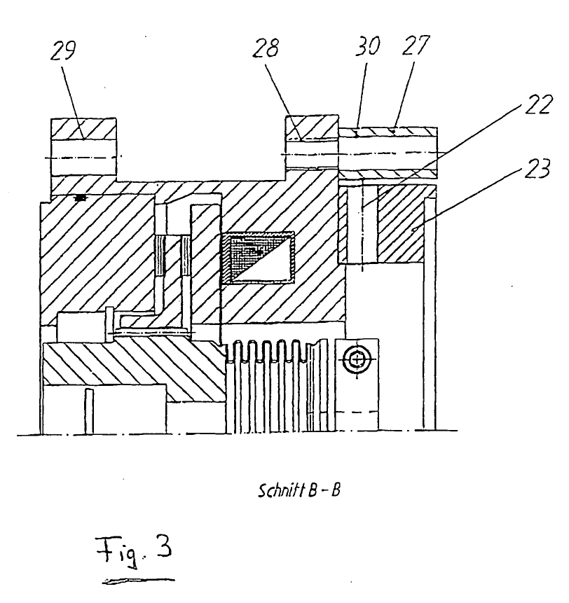

FIG. 3 shows a sectional view similar to FIG. 2, but along line B-B in FIG. 4;

FIG. 4 shows a right-hand view of FIGS. 2 and 3;

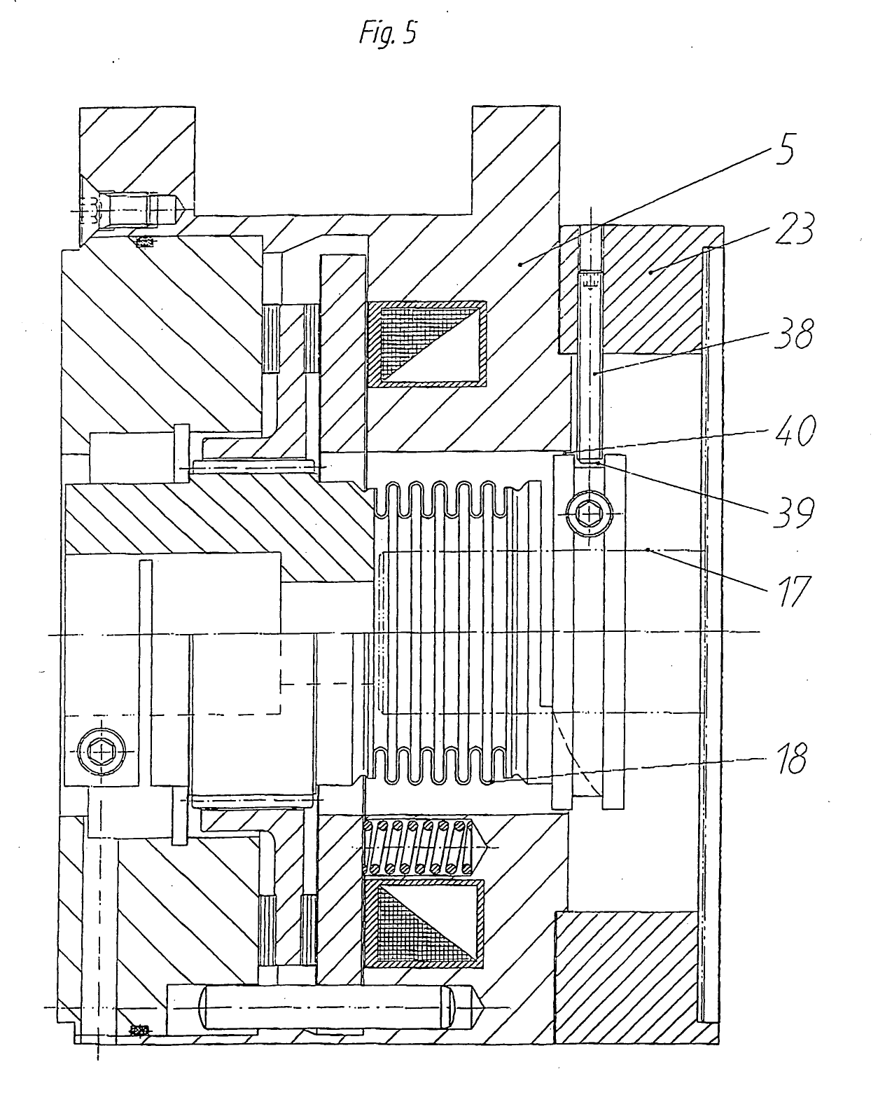

FIG. 5 shows another preferred configuration of the first embodiment of the inventive coupling/brake combination;

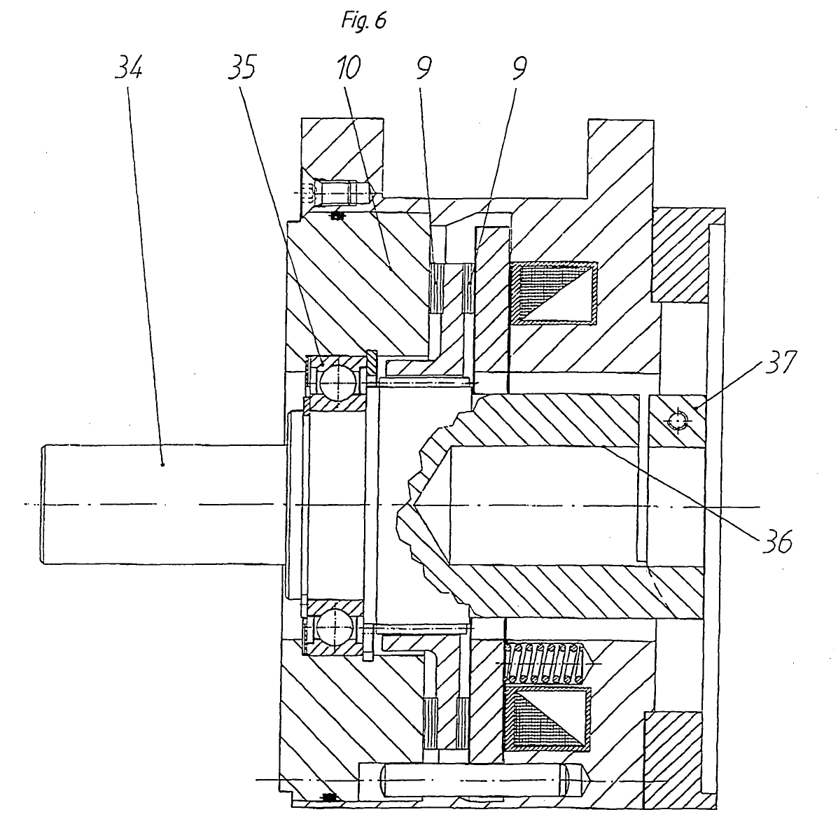

FIG. 6 shows an alternative embodiment of the inventive coupling/brake combination without a flexible coupling but with an additional shaft and the same connecting dimensions as the attached motor (shaft and centering elements with partial attachment circle);

FIG. 7 shows another embodiment of the inventive coupling/brake combination similar to FIGS. 2 and 3, but including a star-type plug-in coupling with a junction box as well as a brake release monitor;

FIG. 8 is an exploded version of FIG. 7 to better show the flexible coupling in the form of a star-type plug-in coupling;

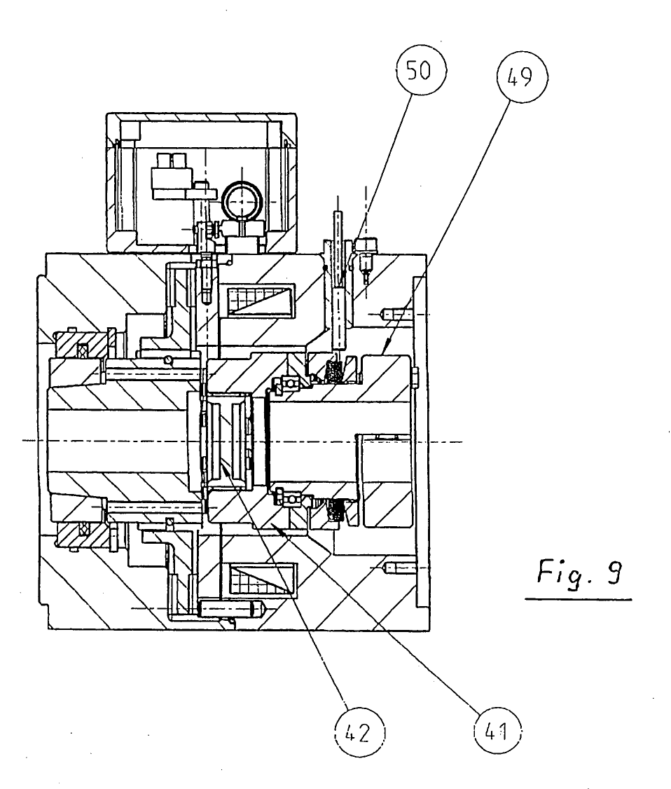

FIG. 9 shows another embodiment of the inventive coupling/brake combination including an integral overload clutch connected to the flexible plug-in coupling;

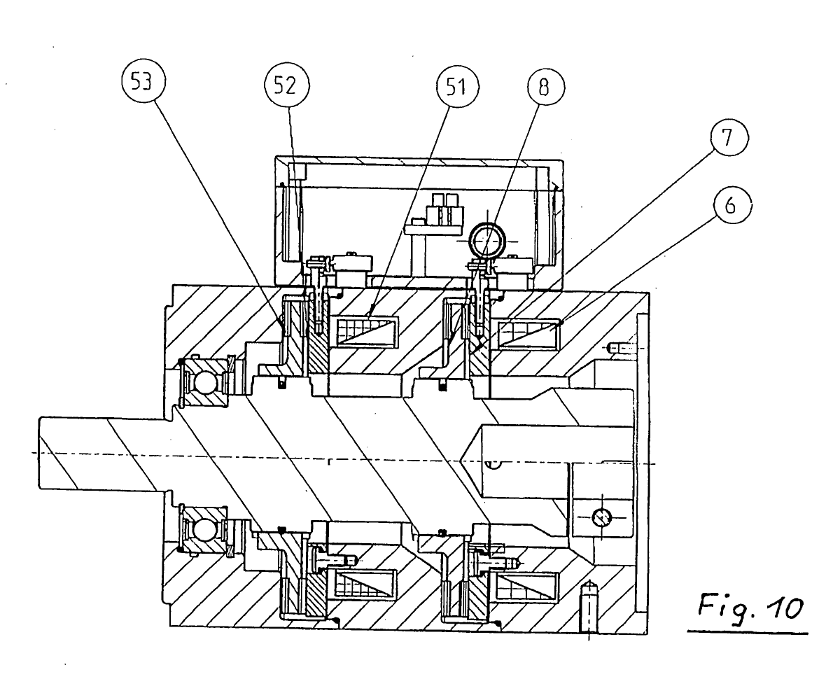

FIG. 10 shows yet another embodiment similar to FIG. 6, including two brakes serially connected to obtain a redundant (dual-circuit) brake system; and

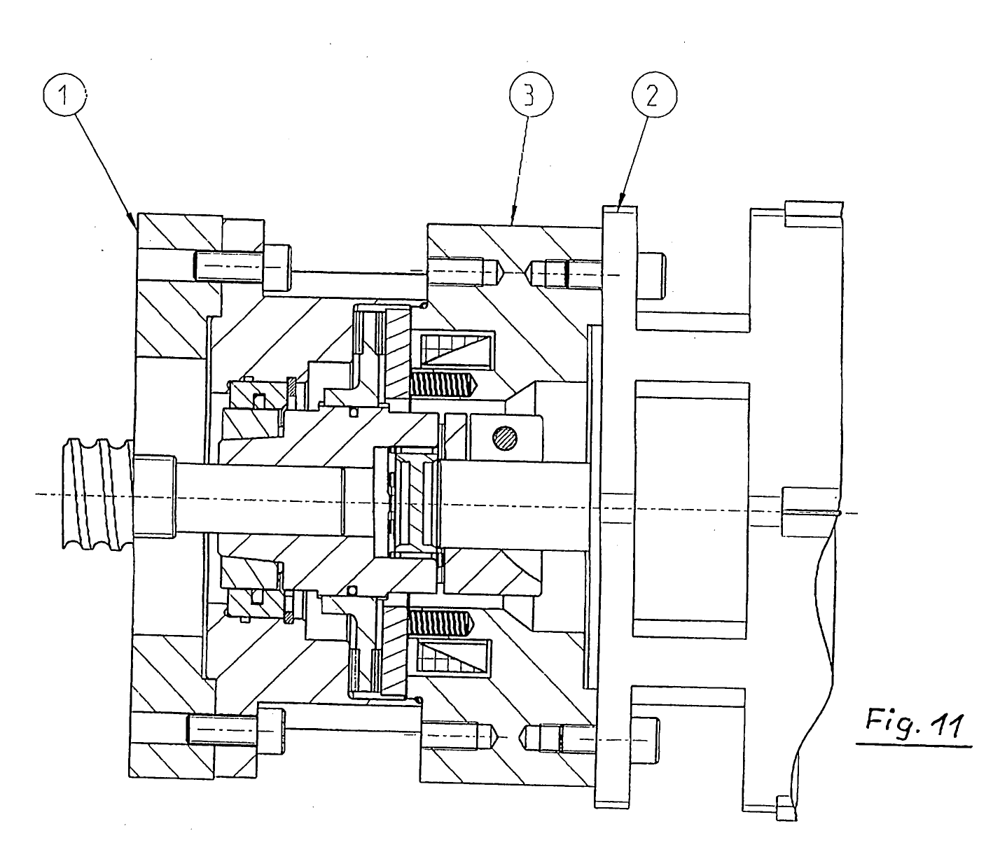

FIG. 11 shows an exemplary application, i.e. the coupling/brake combination attached to a housing with a spindle and a build-on motor.

FIG. 2 shows a preferred embodiment example of the inventive coupling/brake combination, with the essential aspect thereof to be seen in that a static current activated friction brake (=braking action by way of springs in the absence of current) is integrated in the “lantern” (i.e. connector sleeve 3 in FIG. 1), with the brake having its rotor 8 mounted inside the lantern on teeth or splines 13 on central hub 15 of hollow shaft section 16 on the power output side and with the hollow shaft section adapted to be connected with the output shaft by means of a clamp ring 14 to be tightened by a clamp screw 33.

Towards the power input side, hollow power output shaft section 16 has an axial extension in the form of an elastically flexible coupling—in this case a bellows coupling 18 welded in place and having at its power-input end a clamp ring 12, the latter adapted to be tightened by means of a clamp screw 32.

FIG. 2 shows hollow power output shaft section 16 and bellows coupling 18 completely surrounded by an external housing which corresponds to connector sleeve 3 or to the “lantern” in FIG. 1; at the same time, this housing is designed to act as a coil carrier 5 housing magnetic coil or solenoid 6, which cooperates in a well-known manner with axially movable but non-rotating armature disc 7 to attract the latter in the magnetically energized condition against the force exerted by compression springs 19. In the non-energized condition of the coil, compression springs 19 urge armature disc 7 against brake rotor 8 which has friction liners 9 on both sides thereof and is coupled through teeth or splines 13 with hollow shaft 16 to be non-rotating but axially movable therealong. In the braked condition, friction liners 9 engage armature disc 7 as well as brake flange 10, which takes the place of the “lantern”.

In FIG. 2, the right-hand termination is formed (instead of by the “lantern”) by a concentrically attached adjustment ring 23 including centering feature 25 for drive motor 2 (not shown in detail). The adjustment ring has a radial through-bore 22 which enables a tool (for releasing or tightening damp screw 32) to be introduced externally into the assembly. By being adjustable circumferentially, ring 23 ensures constant access to clamp screw 32 regardless of the random rest position of clamp ring 12 when the unit is at standstill.

FIG. 3 shows the apparatus attached in place by means of externally threaded fasteners via spacer sleeves 27 having bores 30 therethrough, said fasteners extending into internally threaded bores 28 in coil carrier 5. Adjustment ring 23 is somewhat shorter than spacer sleeves 27 so that, in the attached condition, adjustment ring 23 can be rotated to bring throughbore 22 in adjustment ring 23 into any position needed to gain access to clamp screw 32 on the motor side of clamp ring 12.

FIG. 4 shows (in a dashed side view) throughbore 22 in adjustment ring 23, through which clamp screw 23 can be accessed.

FIG. 5 shows three or more externally threaded pins 38 equidistantly distributed around the periphery of adjustment ring 23 to ensure that the bellows will not be crushed or damaged in case motor shaft 17 is introduced in a skewed manner in bellows coupling 18. Once pins 38 extend into annular groove 39 in bellows coupling 18, the bellows can never be compressed or excessively stretched when shaft 17 is pushed in or withdrawn. Gap 40 between coil carrier housing 5 and bellows coupling 18 additionally serves to radially limit radial deflections in order to prevent unnecessary excessive radial offsets, which would be likely to permanently damage the coupling. Also, this produces another advantage for transportation of the entire coupling/brake combination.

Hub 15 in FIG. 2 can be designed to have not a hollow shaft section 16 but a solid stub-type shaft section 34, as shown in FIG. 6. Another possibility is to altogether omit the bellows coupling shown in FIG. 2 and to directly introduce motor shaft 17 (shown in phantom in FIG. 5) into the bore of a hollow shaft section 36 and to clamp it in place by means of a clamp ring 37. In this case, brake flange 10 should conveniently incorporate a ball bearing assembly 35. This ball bearing assembly 35 should be a totally encapsulated variety; alternatively, brake flange 10 could be designed to be broader and to have a seal mounted therein to keep any oil or the like away from brake liners 9.

FIG. 7 shows an alternative form of the inventive assembly including plug-in coupling 41 with a resilient star-type coupling member 42. Clamping is accomplished by means of a clamp screw 32 also. On its power output side 2, the clamping of hub 15 is effected by means of a tensioning ring 43 tightened by tensioning screws 44. A sealing flange 45 has therein an annular seal 46 to protect friction liners 9 against dirt and oil.

Junction box 47 houses an brake release indicator 48 (microswitch) adapted to show the operating condition of the brake (disengaged or engaged).

For clarity, FIG. 8 shows an exploded view of the embodiment of the invention including a plug-in coupling 41 incorporating a resilient star member 42. Tensioning screws 44 are used for tightening tensioning ring 43 to connect the output shaft (transmission or gear box, spindle or the like) to the coupling.

FIG. 9 shows an embodiment in which plug-in coupling 41 is connected with an overload clutch 49 which disengages and moves axially in response to an overload condition. The axial movement is picked up by an initiator 50 to deenergize the drive motor, thus protecting the entire drive unit against overload.

FIG. 10 shows a brake system which is redundant in that a second set of magnetic coil 51, armature disc 52 and rotor 53 is included to form a complete second brake.

FIG. 11 shows the attachment of drive motor 2 with its stub shaft and centering feature to the coupling/brake composition shaped like the “lantern”. The coupling/brake combination is then attached to a housing accommodating a spindle or a transmission. The prior art “lantern” 3 of FIG. 1 is omitted and replaced by the inventive coupling/brake combination. An essential advantage of this design is that it enables existing machines to be retrofitted simply and without adaptation work by removing the conventional “lantern” 3 and coupling 4 and installing a coupling/brake combination, thus arriving at the same overall structure. The measure does not entail additional expense, yet it ensures extra safety by providing a spring-actuated brake.

Operation:

The brake uses the well-known static current principle (=braking action by way of springs in the absence of current). Magnetic coil 6 inside coil carrier housing 5 has a voltage applied thereto. This attracts armature disc 7 axially against the pressure exerted by compression springs 19, with the torque transmitted by bolts 20. Thus rotor 8 and its two friction liners 9 can follow the input rotation via the teeth or splines 13 on hub 15, which can rotate freely. In the absence of the energizing current springs 19 urge the armature disc against friction liners 9, so that hub 15 is braked to a standstill.

Drive:

Being introduced into bellows coupling 18 from the right in FIG. 2, motor shaft 17 is adapted to be clamped in position by clamp ring 12 and screw 32. Torque is transmitted from motor shaft 17 to bellows coupling 18 (or star-type plug-in coupling 41) connected to hub 15. Clamp ring 14 allows any stub shaft—as of a transmission or a spindle—to be introduced into hollow shaft section 16. Preferably, hollow shaft section 16 has therein a stop 31 to prevent too great a length of the shaft from being introduced. Clamp ring 14 and screw 33 are then used to clamp and secure the output shaft (of a transmission or spindle) in place, so that torque can be transmitted from the input to the output of the combination as desired.

For installation, the first step is the clamping in place of the transmission shaft, which can be effected via throughbore 21 by means of an Allen-type wrench acting on screw 33. The coupling/brake combination is attached to the transmission or a housing by engaging the centering feature and then securing it in place in four places through bore 29. Connecting screw 11 serves merely to fix housing 5 on brake flange 10.

Motor Attachment:

Motor shaft 17 is introduced in the bellows coupling and clamp ring 12 is clamped in place on the motor shaft by means of Allen screw 32 through bore 22. With centering feature 25 engaged, the motor is fixed in place on adjustment ring 23 and secured by means of threaded bolts to threads 28 via four spacer sleeves 27 and the bores 30 therein.

Advantageous Further Developments:

Adjustment ring 23 is designed to be rotated into any position (in an event such as a motor failure) to align bore 22 with screw 32 of clamp ring 12 for releasing motor shaft 17 in any position and for withdrawing it axially from the coupling. This design results in a self-contained coupling/brake combination which allows the motor to be installed or removed in any rotary position thereof. This is important in the case of motor defects, which prevent the motor from operating and thus from being rotated to any specific disassembly position.

In the embodiment of FIGS. 7 and 8, the advantage of a plug-in coupling over a bellow coupling is that adjustable intermediate ring 23 can be omitted. In that case, the coupling/brake composition can be attached to the housing in its entirety, and it is then that the motor with the plug-in coupling 41 and the resilient star 42 are introduced in the coupling/brake combination and the motor is secured to the latter. Disassembly is possible in any rotary position of the motor as the coupling is pluggable and the motor can be withdrawn together with coupling 41 and star member 42.

### LIST OF REFERENCE CHARACTERS

1 Transmission/spindle or the like
2 Motor
3 Lantern between motor and the transmission
4 Coupling
5 Coil carrier housing
6 Magnetic coil
7 Armature disc
8 Rotor
9 Friction liners
10 Brake flange
11 Connecting screw
12 Clamp ring (motor-side)
13 Teeth or splines
14 Clamp ring (transmission-side)
15 Hub (with teeth or splines 15)
16 Hollow shaft section (transmission-side)
17 Motor shaft
18 Bellows coupling
19 Springs (compression springs)
20 Bolts
21 Bore in the brake flange
22 Bore in the adjustment ring
23 Adjustment ring
24 Centering feature on coil carrier 5
25 Centering feature on the motor adjustment ring
26 Outer centering feature on the brake flange
27 Spacer sleeves
28 Threads in coil carrier 5
29 Throughbore in coil carrier 5
30 Throughbore in spacer sleeve
31 Stop inside hollow shaft section 16
32 Clamp screw (motor-side)
33 Clamp screw (transmission-side)
34 Stub shaft
35 Shaft bearing
36 Hollow shaft section for motor shaft
37 Clamp for motor shaft
38 Threaded pins in adjustment ring 23
39 Groove in clamp ring 12
40 Radial centering feature
41 Plug-in coupling
42 Resilient star
43 Tensioning ring (tapered)
44 Tensioning screws
45 Sealing flange
46 Annular seal
47 Junction box
48 Brake release indicator (microswitch)
49 Overload clutch
50 Initiator (sensor)
51 2nd magnetic coil
52 2nd armature disc
53 2nd rotor

1. Coupling/brake combination, characterized in that the assembly is designed to form a so-called lantern (connector member) accommodating a static current-actuated (spring pressure actuated) integrated brake and a central hub (e.g. bellows coupling or plug-in coupling or shaft having a hollows shaft section) inserted between the input side (motor) and the output side (transmission/spindle or the like), with the brake located on the power output side (transmission/spindle) of the assembly and the assembly being designed so that the end faces of both the input shaft (motor) and the output shaft (transmission/spindle or the like) are in close proximity to each other inside the central hub so as to obtain the shortest possible constructional length of the entire assembly.

2. Coupling/brake combination as in claim 1, characterized in that torque transmission from the input (motor shaft) to the output (hub 15) is effected by an elastically flexible coupling such as a bellows coupling (18) and an associated clamp ring (12), said coupling having a diameter small enough to fit inside the center of the brake and to bring the end faces of both shafts to the closest proximity possible.

3. Coupling/brake combination as in claim 1, characterized by an adjustment ring (23) having a variable rotary position so as to enable clamp screw (32) to be released through radial bore (22) in any rotary position of output clamp ring (12) for installing a new motor in case of a defect.

4. Coupling/brake combination as in claim 1, characterized in that hub (15) is formed to have an axially projecting stub shaft (34, FIG. 6), with the motor shaft being adapted to be introduced directly into a bore (36) in hub (15) and to be clamped in place by means of a clamp ring (37).

5. Coupling/brake combination as in claim 4, characterized in that the hub is centered by an additional bearing assembly (35), said bearing assembly being sealed, and in that the possibility exists of designing brake flange (10) to be broader to accommodate an additional seal for protection of the friction liners from oil.

6. Coupling/brake combination as in claim 1, characterized in that clamp ring (12) is formed to have therein a groove (39) receiving a plurality of externally threaded pins (38) distributed along the ring periphery so as to fix the axial position of the bellows for the assembly and disassembly of motor shaft (17) and prevent it from being crushed or overstretched during assembly.

7. Coupling/brake combination as in claim 1, characterized by an additional gap (40) disposed between coil carrier housing (5) and clamp ring (12) in a manner such that the gap provides an appropriate radial fixing of the bellows coupling to secure it against excessive radial deflection.

8. Coupling/brake combination as in claim 1, characterized in that torque is transmitted from the input side (motor shaft) to the output side (15) by means of an elastically flexible coupling such as a plug-in coupling (41) having an elastic star member (42), with said coupling having a diameter small enough to fit in the brake center and to get the end faces of the two shafts to lie in the closest proximity possible.

9. Coupling/brake combination as in claim 8, characterized in that torque is transmitted from the input (motor shaft) to the output (15) by means of an elastically flexible coupling such as a plug-in coupling (41) having an elastic star member (42), with hub (15) provided with a tensioning ring (43) and having external teeth to receive rotor (8) of the brake for torque transmission.

10. Coupling/brake combination as in claim 8, characterized in that brake flange (10) has a sealing flange (45) inserted therein which receives an annular seal to form a seal against tensioning ring (43) to protect friction liners (9) from dirt and oil.

11. Coupling/brake combination as in claim 1, characterized in that the elastically flexible bellows coupling or star-type plug-in coupling has attached thereto an overload clutch (49) for disconnecting the drive system in response to overload via an initiator/sensor (50).

12. Coupling/brake combination as in claim 1, characterized by a second set of magnetic coil (51), armature disc (52) and rotor (53) provided inside the coupling/brake combination to form a redundant brake system.

13. Coupling/brake combination as in claim 1, characterized by a junction box (47) affixed thereto and housing a break release monitoring system (48) using a microswitch, causing the movement of armature disc (7) to actuate microswitch (48) to issue a signal indicating whether the brake is in the disengaged or engaged condition.
